(19) United States
(12) Patent Application Publication
(10) Pub. No.: US 2010/0200098 A1
(43) Pub. Date: Aug. 12, 2010

(54) Closed end cap for industrial pipes

(75) Inventor: Frederick W. Zeyfang, Erie, PA (US)

Correspondence Address: Muncy, Geissler, Olds & Lowe, PLLC, 4000 Legato Road, Suite 310, FAIRFAX, VA, 22033, US

(73) Assignee: Protective Industries, Inc.

(21) Appl. No.: 12/320,943

(22) Filed: Feb. 9, 2009

(51) Int. Cl. F16L 55/00

(52) U.S. Cl. 138/89; 138/96 R

(57) ABSTRACT

A flexible end cap is provided for the end of an industrial pipe, the end cap comprising a closed end and an open end, the open end defined by a wall extending about the periphery of the closed end, the wall having an interior surface having multiple longitudinal fit beads extending from the interior surface and spaced about the circumference of the interior surface, the longitudinal fit beads extending longitudinally along at least a portion of the interior surface parallel to the longitudinal axis of the end cap, the longitudinal fit beads configured to provide contact along their longitudinal extent with the external surface of a pipe upon the end of the pipe being inserted into the end cap, and the longitudinal fit beads having a tapered end at the uppermost extent thereof.

### BACKGROUND OF THE INVENTION

The present invention is directed to an end cap for industrial pipes.

Dust and debris caps have been used in the piping industry for the past forty years to keep the interior of the pipe clean and free of debris. This feature prevents the need for costly cleaning of the piping system after the pipeline is completed. For instance, after the installation of a domestic water transmission line, it is not uncommon for hundreds of thousands of gallons of water to be flushed through the line to clean the transmission pipe of bacteria before the system can be used for domestic water use. This flushing requirement is costly, and often delays usage of the system. Bacteria often forms and contamination often occurs during transit and storage of the pipe when the pipe is left unprotected.

Historically, pipe caps have had either a consistent uniform wall thickness or, alternatively, radial beads (continuous or interrupted) have been employed along the inside diameter of the cap wall. The radial beads slightly improve the cap fit by allowing only single point contact between the bead diameters and the pipe surface. However, the addition of the radial bead also strengthens the cap wall, thus restricting radial expansion of the cap during use, which may be a disadvantage during extreme temperature conditions.

It has also long been known that pipe end caps while typically molded from a thermoplastic material such as polyethylene are difficult to install and typically do not take into account the manufacturer's tolerance range of the pipe outside diameter. This results in either the end cap being too tight to install, or the end cap being too loose and needing to be secured in position.

Furthermore, thermal expansion and contraction of the pipe in weather extremes requires the cap to have flexibility that adjusts to the size differences of the pipe outside diameter while adjusting for the differences in thermal expansion of the cap material (plastics typically have 5 to 10 times the thermal expansion rate of steel). These conditions create the need for an improved cap design allowing flexibility in fit. Thermal expansion and contraction also causes the air trapped in the pipe as a result of the capping of the ends to expand or contract. Conventional end caps frequently do not provide means for such air to escape from the pipe upon expansion, sometimes resulting in the cap being loosened or removed by the expanding air. As a result, it is typical for holes to be drilled in the end of the cap to permit air flow.

Also, the ends of pipes frequently suffer damage from impact, and conventional pipe end caps do not provide satisfactory impact protection.

It is thus an object of the present invention to provide an end cap for use with industrial pipes that is easily inserted over the end of the pipe, as well as easily removed. It is also an object of the present invention to provide an end cap which provides some impact resistance when installed over the end of the pipe. It is also an object of the present invention to provide an end cap which permits the requisite expansion due to weather extremes. It is still further an object of the present invention to provide an end cap which provides means for the escape of air upon being heated within the pipe under elevated temperature conditions.

### SUMMARY OF THE PRESENT INVENTION

In accordance with the present invention, there is thus provided a flexible end cap for an industrial pipe, said end cap comprising a closed end and an open end, said open end defined by a wall extending about the periphery of said closed end, said wall having an interior surface having multiple compressible fit beads extending inwardly from said interior surface and spaced about the circumference of said interior surface, said beads configured at their innermost point from the wall to provide contact along the longitudinal surface of the beads with the external surface of a pipe upon being inserted into said end cap.

### BRIEF DESCRIPTION OF THE DRAWINGS

FIG. 1 is a perspective view of the end cap of the present invention inserted onto the end of a pipe.

FIG. 2 is a perspective view of the interior of the end cap of the present invention.

FIG. 3 is a cross-sectional view of the end cap of the present invention inserted on the end of a pipe.

FIG. 4 is a cross-sectional view of the end cap of the present invention.

FIG. 5 is an enlarged view of a portion FIG. 4.

FIG. 6 is a cross-sectional view of a portion of the end cap wall of FIG. 3.

FIG. 7 is a cross-sectional view of a portion of the end cap wall of FIG. 5.

FIG. 8 is a perspective view of another embodiment of the present invention.

FIG. 9 is a perspective view of yet another embodiment of the present invention.

FIG. 10 is a perspective view of another embodiment of the present invention.

### DETAILED DESCRIPTION OF THE INVENTION

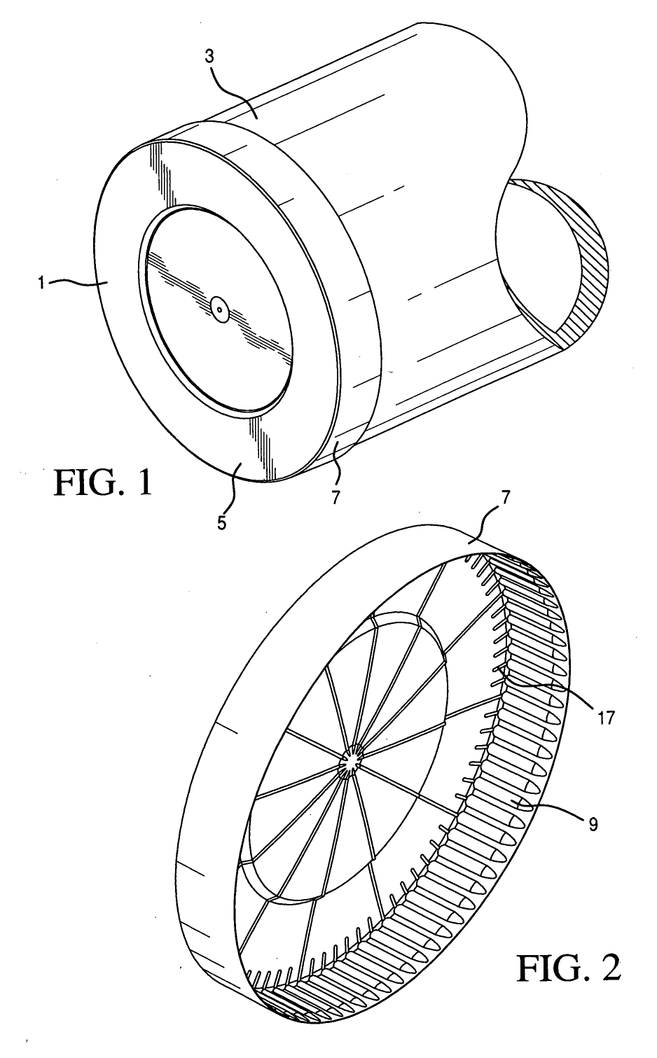

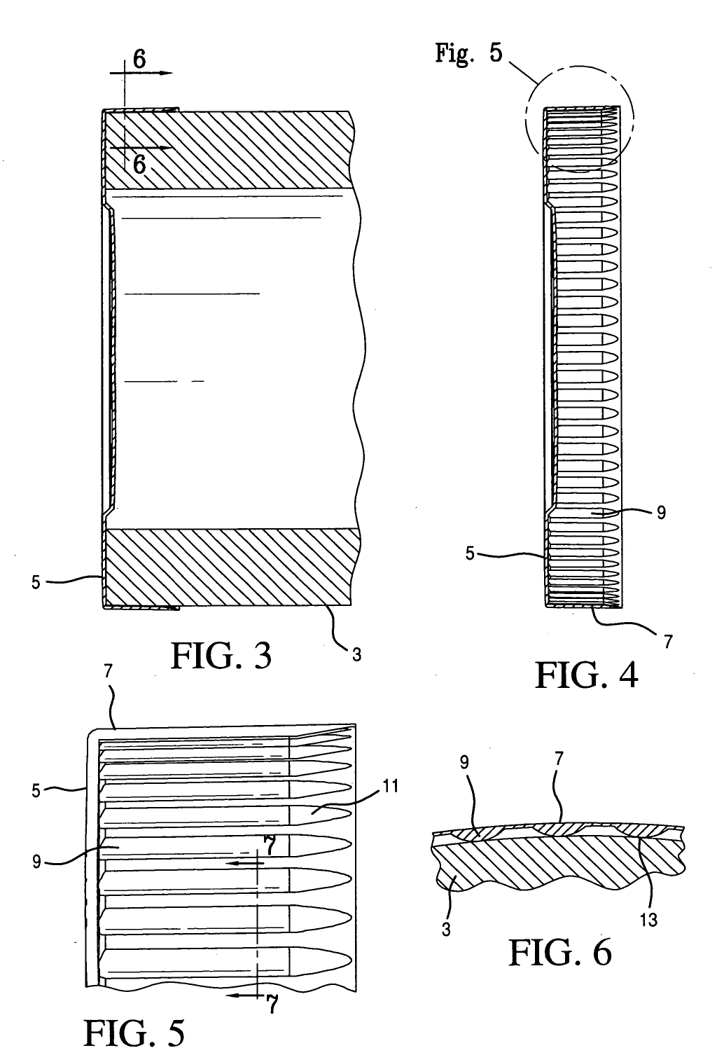

The invention will be described in connection with FIGS. 1-10. The pipe end cap 1 of the present invention comprises a closed end and an open end. The closed end is defined by a planar end surface 5. The open end is defined by an annular wall 7 that extends about the entire periphery of the edge of the planar end surface 5.

The interior surface of the wall 7 has multiple longitudinal fit beads 9 extending inwardly from the interior surface of wall 7 and spaced about the circumference of the interior surface. The beads 9 are configured at their innermost point 13 to provide contact with the pipe along the longitudinal surface of the beads. The external surface of a pipe 3, upon being inserted into the end cap 1, abuts the innermost portion 13 of the surface of the beads 9, and become snugly fit within the end cap body due to the combined action of the beads as they become compressed against the external surface of the pipe.

The beads 9 extend longitudinally along the inner surface of the wall 7, beginning substantially adjacent the end surface 5 and terminating substantially adjacent the top of the wall. Although shown terminating adjacent the top of the wall at the open end, it is within the scope of the invention for the beads to terminate short of the end of the wall, such that the ends of the beads are spaced from the end of the wall. If spaced from the end of the wall, such spacing distance is not particularly critical to practice of the invention. However, for ease of insertion of the pipe into the cap, it is preferred that the beads 9 extend substantially to the end of the wall. The end of the beads 9 has a tapered configuration to permit ease of insertion of the end of the pipe 3 into the end cap 1. The particular form of tapering is not critical to practice of the invention. The slope of the taper is also not critical, and will generally range from about 0.25 to 3 degrees. The beads extend along the interior surface of the wall 7 in a line parallel to the longitudinal axis of the end cap.

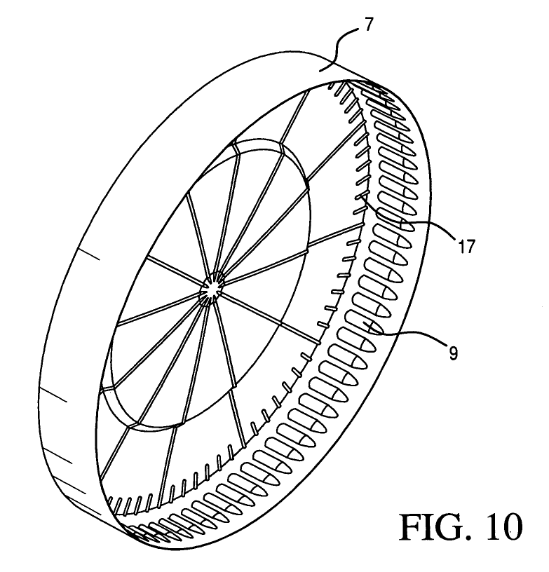

It is not necessary for the beads to run from the bottom of the wall to the top of the wall adjacent the open end. Indeed, as shown in FIG. 10, it is acceptable for the beads to extend along only a portion of the longitudinal extent of the wall in order for the objects of the present invention to be achieved.

The number of beads employed may vary. At a minimum, three fit beads would be employed, preferably equally spaced about the circumference of the wall 7 for purpose of stability upon insertion of the pipe. It is frequently desirable, however, to use a larger number of fit beads in order to minimize the spacing between the beads, while also ensuring a secure fit against the pipe surface due to the greater number of contact points between the fit beads and the pipe wall. A larger number of fit beads also assists in minimizing the entry of extraneous material such as dirt, moisture, etc. into the pipe through the spaces between the fit beads.

By way of further examples, it may be appropriate to use 72 equally spaced fit beads for a 16-18 inch end cap, 84 fit beads with a 20 inch end cap, 108 fit beads with a 24 inch end cap, 132 fit beads with a 30 inch end cap, or 180 fit beads with a 36 inch end cap. Obviously, the number of fit beads employed will depend upon the size of the end cap, the size of the fit beads, and the amount of surface of the end cap desired to have fit beads. For instance, with a one inch end cap, 3-6 longitudinal fit beads may function well, while in a 60 inch end cap several hundred fit beads may be used with advantage.

In most instances, particularly with the larger size end caps of 16 inch diameter or greater, the fit beads would generally be spaced apart with spacing on the order of from 0.20 to 0.30 inch between the fit beads. The diameter of the fit beads depends upon the size of the end cap, with smaller end caps having fit beads of smaller dimension than larger end caps By way of example, end caps having a diameter of from 16-60 inches would generally have longitudinal fit beads of a size within the range from about 0.50 to 0.75 inch. The above embodiments are provided solely by way of example, and are not intended to be limiting as to the ultimate scope of the present invention. For example, different diameters of end caps may be employed, as well as different numbers of fit beads used in the end caps.

It is contemplated that the end caps of the present invention may be used with a variety of pipes of different sizes, such as pipes having an outside diameter of from ¼ inch to 60 inches.

The fit beads may be of any configuration which provides the requisite contact with the pipe wall. While rounded bead heads 13 are shown in the Figures, beads having a more triangular configuration, or beads which have a more flattened upper surface, may be used with advantage.

The fit beads do not all need to be equally spaced about the circumference of the wall 7, nor do the fit beads have to be placed about the entire circumference. It is only necessary for sufficient fit beads to be at sufficient points about the circumference for the end cap to be snugly attached to the pipe.

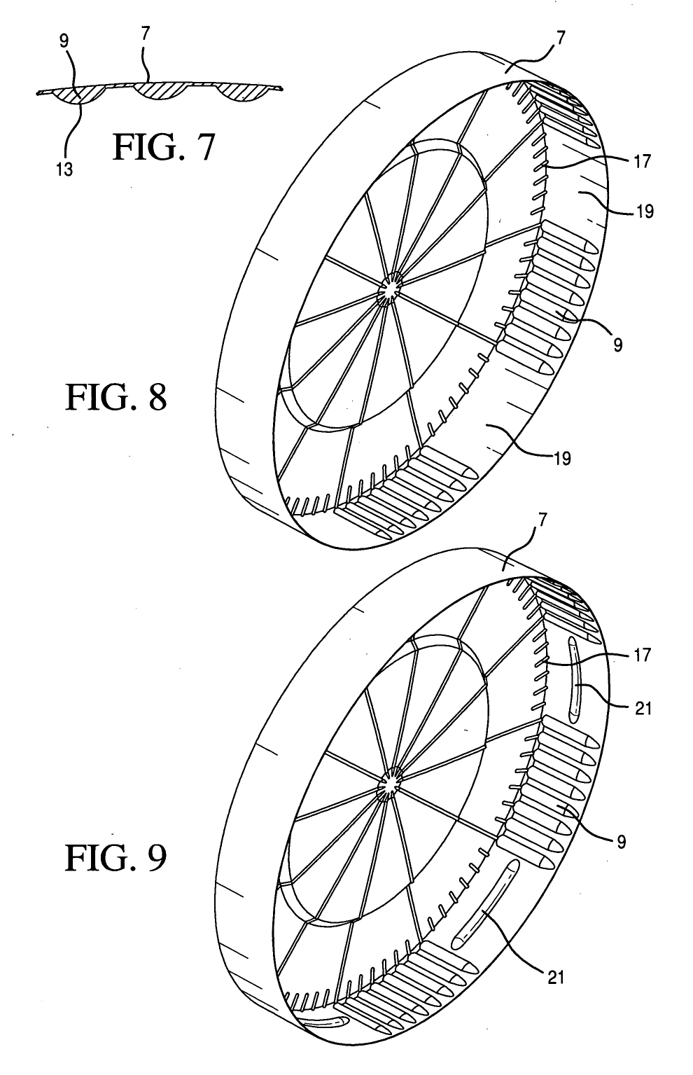

For instance, as shown in FIG. 8, the fit beads may be employed in groupings about the circumference of the wall 7. That is, as shown in FIG. 8, multiple groupings of, for instance, 8 equally spaced fit beads may be present along the circumference, with a larger space 19 being provided between the respective groupings of fit beads than between the individual fit beads within the groupings. Other configurations may occur to those skilled in the art, such as groupings with smaller or larger numbers of fit beads, or different numbers of groupings about the circumference, which are within the scope of the invention. It is merely necessary for there to be sufficient contact between the fit beads and the pipe wall for the end cap to be securely attached to the pipe.

Preferably, the space between adjacent fit beads is generally 4 inches or less, preferably 2 inches or less (each for larger end cap diameters), depending on the size of the end cap. Fit beads can be essentially touching adjacent fit beads, with a minimum spacing of about 0.010 inch desirable. Preferably, the space between the fit beads ranges from about 0.20 to about 0.30 inch, with the exception of when the fit beads are grouped about the circumference, in which case the groups of fit beads themselves may be spaced further apart.

The size (diameter and height) of the fit beads is not critical, and is generally determined by the diameter of the end cap. For instance, for end caps having a diameter of 16 inches or greater, the fit beads will generally have a diameter and height of from 0.50 to 0.75 inch as measured along the interior surface of the wall 7. However, once the pipe is inserted into the end cap, some compression of the fit bead occurs such that the ratio of the height of the fit bead to its width decreases. See, for instance, the change in geometry of the fit bead when comparing the fit bead of FIG. 6 (when compressed against the pipe) and the non-compressed fit bead of FIG. 7. It is important for the fit bead to have sufficient height so as to enable the fit bead to have adequate mass to be compressed in a manner which serves to maintain the end cap in place on the pipe wall.

It is advantageous to provide bead segments 17 on the inner wall of the end 5 which bead segments extend inwardly a short distance from the bottom of the longitudinal bead 9 toward the center of the end cap end wall. The bead segments 17 serve as a seat for the end of the pipe, and provide a space for air to exit the pipe and pass upwardly in a space between the longitudinal fit beads along the wall of the end cap.

It is also possible for the end cap to include one or more annular fit beads 21 which extend laterally about the circumference of the wall 7, with the annular fit beads 21 extending partially about the circumference as shown in FIG. 9. Such an embodiment may find its greatest use when a smaller number of longitudinal fit beads 9 are employed, or where groups of fit beads are employed, such that there may be significant spacing between the longitudinal fit beads as shown in FIG. 8. The presence of the laterally-extending or annular fit beads 21 assists in providing additional contact surface with the pipe wall. The presence of a laterally-extending fit bead 21 near the open end of the end cap may also assist in sealing the interior of the end cap from dirt and/or moisture. Again, such annular fit beads 21 do not extend about the entire circumference of the wall, but are present as multiple segments only in spaces between the longitudinal fit beads as may be desirable as shown in FIG. 9. Such an embodiment permits the wall of the end cap to retain some annular expansion ability within the circumferential areas of the wall where the longitudinal fit beads are present, while still providing some strengthening in those areas where the annular fit beads are present.

Also, it is within the scope of the present invention for multiple annular fit beads 21 to be employed along the longitudinal axis of the end cap. In such a case, annular fit beads may be positioned, for example, at the same or different locations (e.g., in the same or different quadrants) in separate planes spaced along the longitudinal axis of the end cap oriented perpendicular to the longitudinal axis. For instance, two annular fit beads may be employed which reside in opposing first and third quadrants in one perpendicular plane, while the two annular fit beads may be located in opposing second and fourth quadrants of a second perpendicular plane, with each plane being spaced from each other along the longitudinal axis of the end cap. The potential choices are numerous, and the manner of choice of same is well within the skill of the routineer in the art.

The geometry of the wall and the fit beads enables several advantages to be achieved. Since the combined thickness of the fit beads and the adjacent wall is significantly greater than thickness of the wall portion which forms the space between the fit beads, this enables the wall portion between the fit beads to be smaller in thickness than might normally be the case. Indeed, the thickness of the wall portion may be reduced by up to 50 percent or so. This enhances the flexibility of such wall portion and enables the end cap wall to flex more easily under extreme temperature conditions.

The end cap of the present invention may be produced by conventional injection molding techniques. The material employed for the end cap will typically be polyethylene, for the reason that it is cost-effective, is flexible, and provides good weather resistance. Either low density or linear low density polyethylene are preferred molding materials for use in the present invention. While polypropylene is itself too rigid for use in the present invention, a polypropylene mixture with an elastomer or ethyl vinyl acetate (each added to improve flexibility) may also be acceptable.

What is claimed is:

1. A flexible end cap for the end of an industrial pipe, said end cap comprising a closed end and an open end, said open end defined by a wall extending about the periphery of said closed end, said wall having an interior surface having multiple longitudinal fit beads extending from said interior surface and spaced about the circumference of said interior surface, said longitudinal fit beads extending longitudinally along at least a portion of said interior surface parallel to the longitudinal axis of said end cap, said longitudinal fit beads configured to provide contact along their longitudinal extent with the external surface of a pipe upon the end of the pipe being inserted into said end cap, and said longitudinal fit beads having a tapered end at the uppermost extent thereof.

2. The end cap of claim 1, wherein said longitudinal fit beads are evenly spaced about the entire circumference of said wall.

3. The end cap of claim 1, wherein said longitudinal fit beads are present in groups spaced from one another which groups are spaced about the circumference of said wall, said spacing between said groups being greater than the spacing between said longitudinal fit beads.

4. The end cap of claim 1, wherein said fit beads have a curved surface.

5. The end cap of claim 3, wherein at least one annular fit bead is present in at least one space between said spaced apart groups of longitudinal fit beads.

6. The end cap of claim 1, wherein said longitudinal fit beads extend from said closed end to said open end of said end cap.

7. The end cap of claim 1, wherein said longitudinal fit beads terminate at a point spaced from said open end.

8. The end cap of claim 1, wherein said longitudinal fit beads terminate at a point spaced from said closed end.

9. The end cap of claim 1, wherein said longitudinal fit beads extend from a position spaced from said closed end to a position spaced from said open end.

10. The end cap of claim 1, wherein said end cap includes multiple radial fit beads along said closed end as stops for said pipe end.
